(19) United States
(12) Patent Application Publication
(10) Pub. No.: US 2006/0170298 A1
(43) Pub. Date: Aug. 3, 2006

(54) Liquid spray shield for liquid-cooled alternators

(76) Inventor: Samuel R. Edrington, Noblesville, IN (US)

Correspondence Address: James J. Merrick;Cantor Colburn LLP, 55 Griffin Road South, Bloomfield, CT, 06002, US

(21) Appl. No.: 11/046,013

(22) Filed: Jan. 28, 2005

(51) Int. Cl. H02K 5/15

(52) U.S. Cl. 310/90; 310/89

(57) ABSTRACT

A spray shield for a bearing assembly of an electrical machine includes a shield disposed intermediate an outermost bearing and rubber seal lip of a seal. The shield has an aperture allowing a rotor shaft to extend therethrough. The seal is configured to at least one of reduce hydraulic pressure at the seal lip and reduce a liquid leaking through the seal lip.

### TECHNICAL FIELD

This application relates generally to the field of liquid spray shields in rotating electrical machines. More specifically, this application relates to liquid spray shields in rotating electrical machines, especially dynamoelectric machines including oil-cooled alternators (generators), such as those found in large city busses and coaches.

### BACKGROUND

Rotating electrical machines such as vehicle alternators (dynamoelectric machines) (also commonly referred to as “generators”) having a stator secured within the housing of the machine and a rotor assembly that extends axially through the motor or generator are well known. The housing often includes two or more spaced apart frames which provide the main structural elements of the alternator. The frame closest to a pulley, which powers the alternator via a belt drive is commonly referred to as the drive end frame. The opposite frame is commonly referred to as the slip ring end frame. The frames support the rotor assembly comprising a rotor shaft with or without a connected rotor winding. Support bearings for the rotor assembly are typically positioned “inboard” of the pulley that turns the rotor of the generator via a fan belt from the engine, the pulley also being attached to the rotor assembly. The frames are held together typically by three or more bolts which are attached axially between ears or bosses on the outside of the frames.

Each frame has a hub. The hub includes an inner core having a central axial opening (sometimes referred to as the bearing bore). The inner core axial opening provides mounting support for an outer race of a bearing (e.g., roller or ball bearing), which mounts the rotor shaft to the hub. The outer race of the bearing is typically press fitted within this central opening of the core.

Vehicle alternators with high output capability are used in large vehicles such as trucks, busses and passenger coaches. The alternator provides current for the vehicle which is used to charge the vehicle's battery or to run various auxiliary systems. When the alternator is operating as a generator of electricity, some amount of heat is also generated by the alternator. As the current demand on the alternator is increased, the alternator will attempt to generate more electricity, thereby increasing the heat generated.

Under conventional circumstances, a diode rectified alternator may be cooled by circulating a liquid, such as oil, through the alternator housing and around the internal components of the alternator. In a basic system, cooling oil is pumped into the alternator. The heat generated by the internal components of the alternator is then transferred to the comparatively cooler oil, thus cooling the alternator components and heating the oil. The heated oil is then conveyed out of the alternator to a heat exchanger where the oil is cooled so that it can be recirculated to the alternator for further cooling.

In the above system, it should be noted that a shaft seal is used in conjunction with the rotating shaft to retain the oil within the alternator housing. Currently a rubber seal lip is used to hold back the spraying oil while maintaining contact with the rotating shaft. However, shaft seals leak oil, creating negative cosmetic conditions and, if leaking at a high enough rate, may cause the vehicle operator to be subjected to fines from local, state or federal government agencies. Furthermore, oil spray from a rotating bearing can increase the hydraulic pressure at the rubber seal lip of the input shaft seal and increase leakage of oil through the seal. Leakage is exacerbated when there is radial misalignment of the placement of the seal and/or there is some eccentricity of the seal contact surface of the shaft.

Accordingly, a method and apparatus is desired that prevents high velocity oil spray from directly contacting the seal lip while allowing both radial misalignment of the placement of the seal and some eccentricity of the seal contact surface of the shaft.

### BRIEF SUMMARY OF THE INVENTION

The above discussed and other drawbacks and deficiencies are overcome or alleviated by the placement of a metal shield behind a rubber seal lip of an oil seal for the rotor shaft thus preventing high velocity liquid spray from directly contacting the seal. More specifically, the shield is placed between an outermost bearing and the oil seal. The shield prevents high velocity liquid cooling spray, such as oil spray, emitted from the bearing from contacting the rubber seal lip. This design allows both radial misalignment of the placement of the seal and some eccentricity of the seal contact surface of the shaft.

In an exemplary embodiment, a spray shield for a bearing assembly of an electrical machine includes a shield disposed intermediate an outermost bearing and rubber seal lip of a seal. The shield has an aperture allowing a rotor shaft to extend therethrough. The seal is configured to at least one of reduce hydraulic pressure at the seal lip and reduce a liquid leaking through the seal lip.

In another embodiment, a liquid-cooled rotating electrical machine is disclosed. The electrical machine includes: a rotor having a longitudinal axis; a stator surrounding the rotor; one or more frames rotatably supporting the rotor, at least one of the frames having a hub with a core with an opening for receiving a bearing mounting the rotor with the hub; and a spray shield disposed intermediate the bearing and a rubber seal lip of a seal. The shield has an aperture allowing a rotor shaft to extend therethrough. The seal is configured to at least one of reduce hydraulic pressure at the seal lip and reduce a liquid leaking through the seal lip.

In yet another embodiment, a method to suppress oil spray generated in a brush or brushless type rotor of a wound-field electrical machine is disclosed. The method includes disposing a metallic shield intermediate an outermost bearing and rubber seal lip of an oil seal. The shield has an aperture allowing a rotor shaft to extend therethrough. The seal is configured to at least one of reduce hydraulic pressure at the seal lip and reduce a liquid leaking through the seal lip

### BRIEF DESCRIPTION OF THE DRAWINGS

FIG. 1 is a cross sectional assembly drawing of a conventional oil-cooled alternator illustrating an oil seal in conjunction with a gasket disposed intermediate an outboard end of a drive end bearing assembly and a pulley at a drive end of the alternator;

FIG. 2 is a partial enlarged cross section view the drive end of the alternator of FIG. 1 with the pulley removed illustrating an oil seal case having an oil spray shield in accordance with an exemplary embodiment;

FIG. 3 is an enlarged cross section view of the oil seal case having the oil spray shield of FIG. 2;

FIG. 4 is a enlarged cross section view the drive end of the alternator of FIG. 1 with the pulley removed illustrating the gasket having an oil spray shield in accordance with an exemplary embodiment;

FIG. 5 is a plan view of gasket material applied equally to the oil spray shield of FIG. 4 in accordance with an exemplary embodiment;

FIG. 6 is a plan view of a thin metal shield used the oil spray shield of FIG. 4 in accordance with an exemplary embodiment;

FIG. 7 is an enlarged plan view of a shield assembly having the oil spray shield of FIG. 6 sandwiched by the gasket material of FIG. 5 in accordance with an exemplary embodiment;

FIG. 8 is a side view of FIG. 7; and

FIG. 9 is a partial cross section view of FIG. 1 illustrating a cooling oil inlet, drain, including passages and flow through various components of the alternator.

### DESCRIPTION OF THE PREFERRED EMBODIMENT

This disclosure relates to a method and apparatus for reducing hydraulic pressure and liquid spray at the rubber lip of the input shaft seal while reducing or eliminating oil leaks through the seal. The present disclosure provides an improvement over previous designs in that it allows both radial misalignment of the placement of the seal and some eccentricity of the seal contact surface of the shaft.

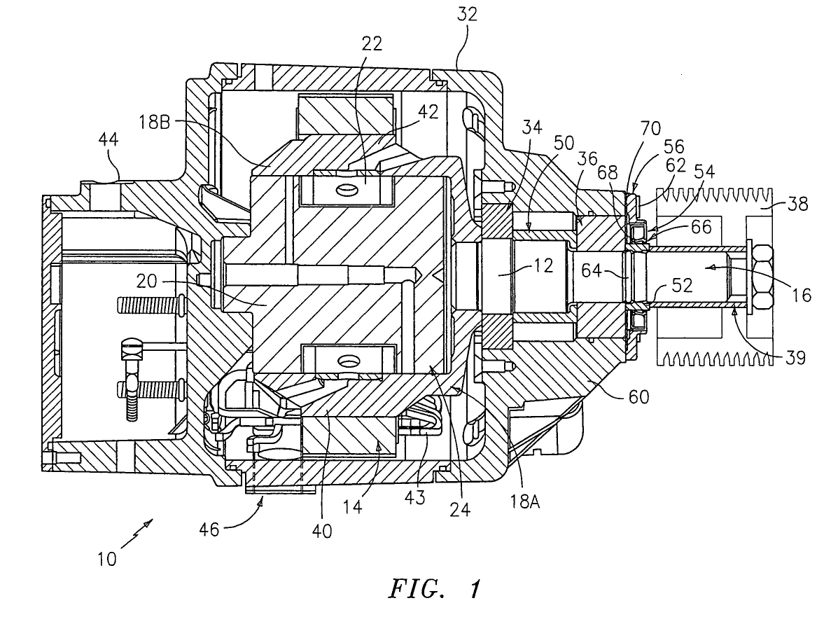

Referring now to FIG. 1, an alternator 10 has a rotor assembly generally designated by the reference numeral 12 and stator assembly generally designated by the reference numeral 14. The rotor assembly 12 includes a shaft 16 supporting all rotating magnetic circuit structures thereof including conventional pole-members or segments 18A and 18B, and possibly a rotor core 20 and field coil 22 wound upon bobbin 24. Each segment 18A and 18B has P/2 claw poles where P is an even number and representative of the total number of poles. Additionally, all other non-magnetic circuit rotating structures are carried thereby, possibly including a slip ring assembly (not shown, as in a brush-type Lundell machine) located at one extreme end of the shaft. FIG. 1 depicts a brushless design. The shaft 16 in turn is rotatably supported within a drive-end frame housing 32 by a ball bearing assembly 34 and a roller bearing assembly 36 disposed proximate a pulley 38. Pulley 38 is disposed at a pulley section 39 of shaft 16.

As described above, the rotor assembly 12 is constituted by: shaft 16; possibly the field winding 22 for generating a magnetic flux on passage of an electric current (i.e., brush design); and pole cores or segments 18A and 18B disposed so as to cover the field winding 22, magnetic poles being formed in the segments 18A and 18B by the magnetic flux generated by the field winding 22. The segments 18A and 18B are preferably made of iron, having two first and second claw-shaped magnetic poles 40 and 42, respectively, disposed on an outer circumferential edge and offsetly aligned with each other in a circumferential direction so as to project axially, and the end segment pole cores 40 and 42 are fixed to the shaft 16 facing each other such that the claw pole of one core is aligned with a gap defined between contiguous claw poles of the other core and intermesh with the opposing magnetic poles of the other core as is well known in the art of Lundell rotor assemblies.

In the dynamoelectric machine 10 constructed in this manner, an electric current is supplied to the field winding 22 during start up from a storage battery possibly through brushes and slip rings (all not shown), generating a magnetic flux. After the alternator turns on and begins to produce power, the alternator may provide the field current internally. The first claw-shaped magnetic poles 40 of segment 18A are magnetized into a fixed polarity by this magnetic flux (such as North seeking (N) poles), and the second claw-shaped magnetic poles 42 of segment 18B are magnetized into the opposite polarity (such as South-seeking (S) poles). At the same time, rotational torque from the engine is transmitted to the shaft 16, by means of the belt (not shown) and the pulley 38, rotating the rotor assembly 12. Thus, a rotating magnetic field is imparted to an armature winding 43 of stator assembly 14, inducing a voltage across the armature winding 43. An alternating-current (AC) electromotive force from induced voltage across armature winding 43 passes through a rectifier (not shown) and is converted into direct current, the magnitude thereof is adjusted by a voltage regulator, the storage battery is charged, and the current is supplied to an electrical load. In other words, as the rotor shaft 16 is rotated by the power of the engine, the field coil 22 is excited in this state through the voltage regulator, an AC output is generated in the stator 14, with the AC output being rectified by the rectifier and, supplied to a battery (not shown) and electric load (not shown).

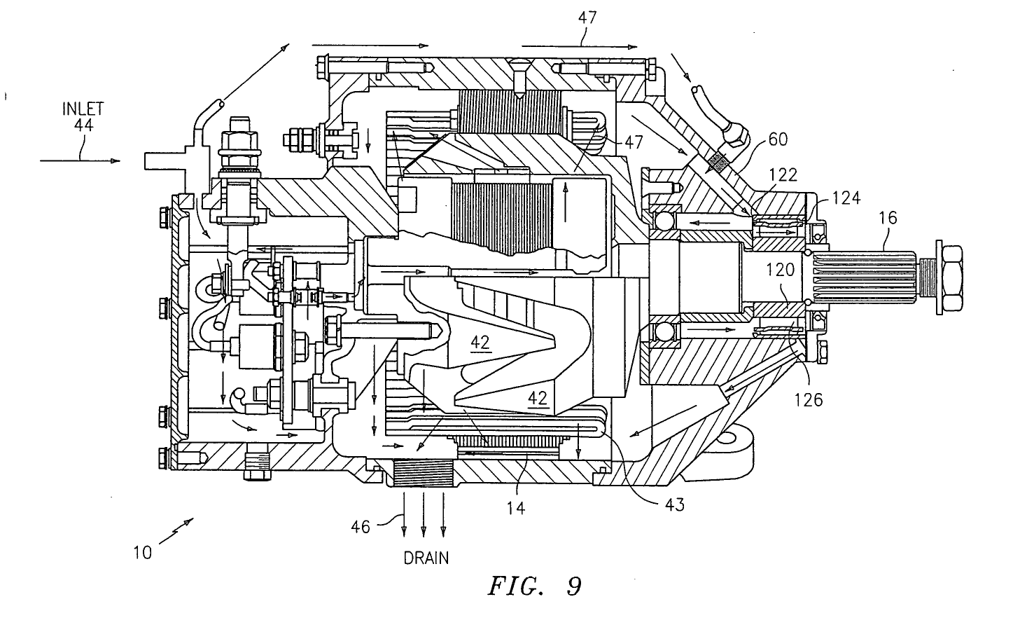

During the operation of the alternator referring to FIG. 9, engine lubricating oil is supplied by an oil pump (not shown) to an oil inlet 44, with the oil then flowing in oil passages indicated with arrows 47. The oil passing through the oil passages 47 is sprayed in the form of vapor or mist onto front and rear portions of the stator 14 by the centrifugal force generated as a result of rotation of the rotor 12, whereby the stator coil of stator 14 is cooled by the sprayed oil. Meanwhile, a fraction of oil which does not reach the stator coil and a fraction of the oil which drips from the stator coil attach to the field coil 22 thereby cooling the same. Then, the oil flows along the inner surface of housing 32 and other portions and then flows down into the bottom of housing 32 by the force of gravity. The oil then returns to the lubricating oil reservoir through an oil outlet 46]. It will be seen and recognized that the oil serves also to lubricate the bearings 34 and 36.

In the illustrated embodiment, the oil is recirculated through the described circuit so that the heat-generating parts such as the stator coil, the field coil 22, the rectifier and so forth are effectively cooled. In particular, the stator coil and the field coil 22 are highly effectively cooled by virtue of the direct spray of the oil vapor thereto, whereby the output characteristic of the alternator can be remarkably improved. In addition, the cooling means can simply and easily be formed by slots, grooves and minute gaps formed in or on the rotor, so that the size and the weight of the alternator can be reduced. Furthermore, since the described alternator can have a hermetic construction free from invasion by external foreign matters such as dust and water, it can suitably be used as alternators on vehicles such as automobiles, buses, trucks, small vessels and so forth.

Still referring to FIG. 1, support and sealing of rotor shaft 16 at the drive end frame will be described in more detail. A spacer 50 is disposed between bearings 34 and 36. Another spacer 52 surrounds shaft 16 and is disposed on an opposite side of bearing 36 surrounded by an oil seal case 54. Oil seal case 54 in turn is surrounded by a seal retainer plate 56 that is bolted via a bolt 62 to drive-end frame 60 defining drive end frame housing 32. An O-ring 64 is disposed in a complimentary configured groove in shaft 16 which forms an oil seal on one side of spacer 52. A seal lip of oil seal case 54 generally indicated at 66 forms an oil seal on an opposite side of spacer 52. An annular coil spring 68 circumferentially surrounds seal lip 66 ensuring communication of stationary seal lip 66 with revolving spacer 52 that rotates with shaft 16. It will be noted that seal lips are usually molded of a resilient elastomeric or polymeric material. They are secured in fluid tight relation to a housing and surround a rotating shaft which extends through an aperture in the housing wall. The sealing lip is in sealing relationship to the shaft to contain the fluid in the housing. A gasket 70 is disposed intermediate seal retainer plate 56 and drive end frame 60 preventing oil from leaking therethrough.

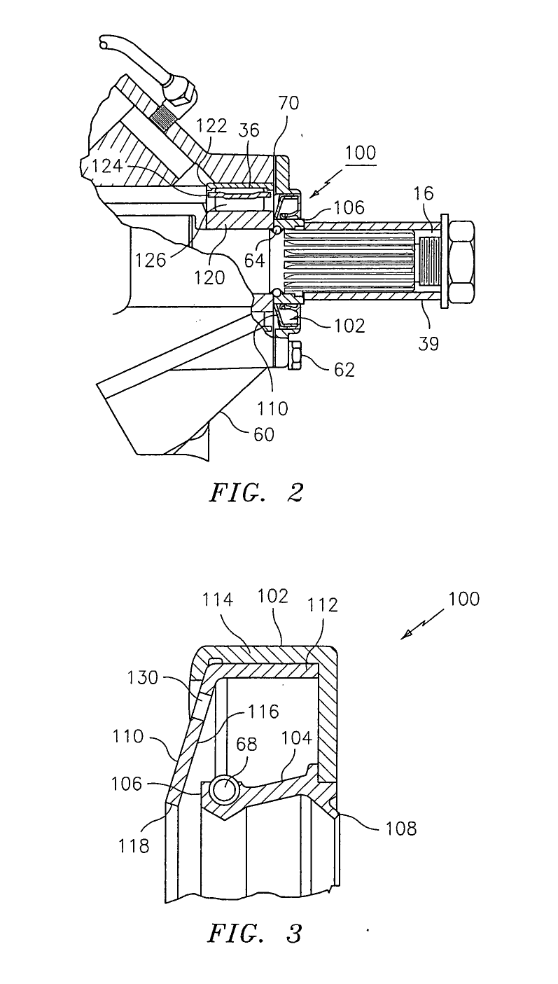

Referring now to FIGS. 2 and 3, an oil seal case 100 similar to seal case 54 of FIG. 1 will be described in accordance with an exemplary embodiment. Seal lip components or elements include a rigid case or retainer 102 to add rigidity and unitize the seal assembly with reference to FIG. 3. The case 102 also aids installation, withdrawal and retention of the seal relative to the housing. A resilient body 104 defining seal lip 106 includes a secondary seal 108 to seal against spacer 52 and one or more resilient sealing lips 106 opposite thereto which are maintained in sealing contact with spacer 52.

An oil spray shield 110 is disposed within case 102 to prevent high velocity oil spray emitted from bearing 36 from contacting the rubber seal lip 106. Shield 110 includes a first member 112 disposed against an outboard wall 114 defining case 102 and a second member 116 extending from a terminal end of first member 112 and not co-planar therewith. Shield 110 is installed into a back of the case 102 of a conventional oil seal. Shield 110 is formed of a material similar to case 102 and includes an aperture centrally disposed for fitting over shaft 16 defined by a radially inwardly extending terminal end 118 defining second member 116. In an exemplary embodiment, for example, case 102 is a metal case. Shield 110 prevents oil spraying out of bearing 36 from reaching rubber seal lip 106 while remaining out of contact with shaft 16. Second member 116 defining shield 110 is angled outward from a plane defining opposing sides defining the seal case in order to be positioned more effectively in the path of the oil spray. More specifically, terminal end 118 extends towards an inner race 120 of roller bearing 36 while proximate but out of contact with an exterior surface defining spacer 52. In other words, an inside diameter (I.D.) of shield 110 is larger than an ID of seal lip 106, as best seen in FIG. 3. In addition, a width of case 102 defined by outboard wall 114 is less than a width of shield 110, as best seen in FIG. 3.

Bearing 36 is illustrated as a roller bearing 36, for example, having four distinct parts in FIGS. 2, 4 and 9. The inner race 120 is pressed onto the shaft 16, an outer race 122 is a U-shaped section, as illustrated, and is pressed in a bore defined by drive-end frame 60, a “cage” 124 is shown as a wave shaped section disposed across an actual rolling element 126 that would splash the oil.

Shield 110 may include three drain holes 130, for example, to allow the oil to exit an area immediately behind the seal. The three holes are located to allow any clocking position of the seal during assembly, thus eliminating assembly errors. This concept allows for easier installation of the shield for both field servicing of the seal and future designs of the alternator 10 that may eliminate the use of gasket 70. More specifically, it is envisioned that the drive end housing may be modified to directly accept a larger cased seal, in which case the retainer and gasket are not needed

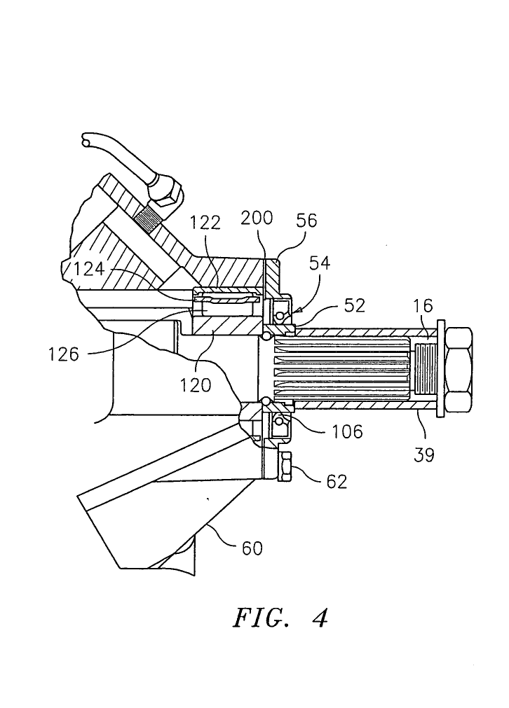

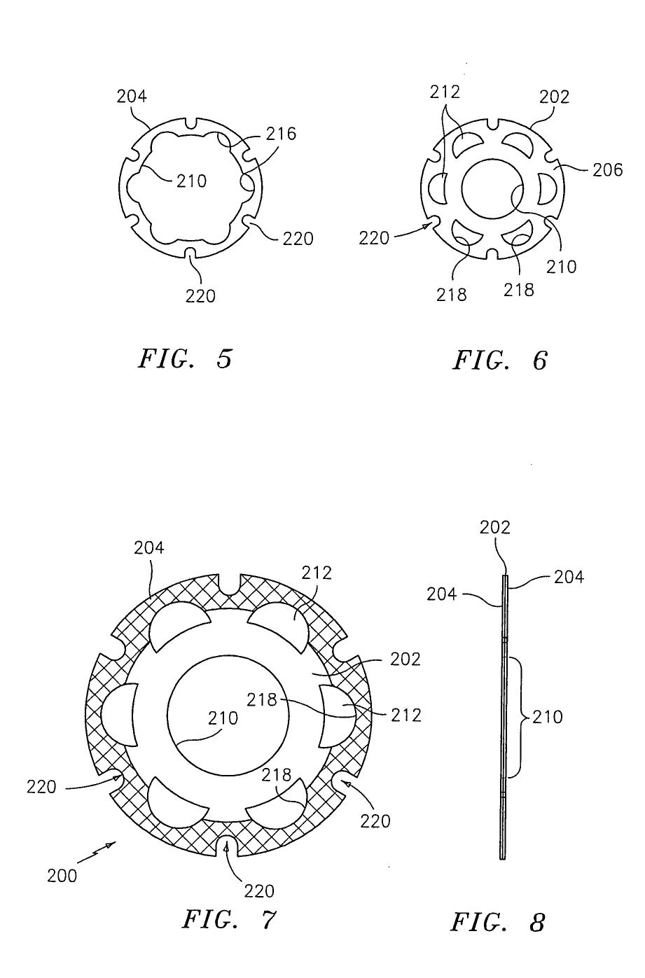

Referring now to FIGS. 4-8, a gasket or shield assembly 200 similar to gasket 70 of FIG. 1 will be described in accordance with an exemplary embodiment. Gasket 200 includes a frame 202 (FIG. 6) and a gasket 204 (FIG. 5) disposed on opposing surfaces 206 defining frame 202 (FIGS. 7 and 8). Frame 202 is a thin metal shield disposed between opposing gaskets 204 of gasket material forming a shield assembly 200 that is disposed in a position currently occupied by gasket 70 of FIG. 1. Shield assembly 200 seals an interface between seal retainer plate 56 and drive-end frame 60 and is substituted for gasket 70.

Shield assembly 200 includes a centrally located aperture 210 large enough to allow installation over input shaft 16, and at least one drain hole 212 (six shown) that allows the oil to exit an area between the retainer plate 56 and the drive-end frame 60. At least one drain hole 212 is in fluid communication with an oil passage (not shown). The drain holes 212 are located in positions that allow the shield assembly to be assembled in any one of six positions, like the current gasket 70 in order to eliminate assembly errors. In this manner, at least one drain hole will be aligned with an oil passage thus reducing hydraulic pressure on seal lip 106. In an exemplary embodiment as illustrated, each drain hole 212 is proximate an outside edge defining frame 202 and has a crescent shape, however, other suitable shapes are contemplated. In this manner, shield 202 prevents direct oil spray at seal lip 106 and prevents a build up of hydraulic pressure thereon by directing the spray radially outward.

The gasket material is disposed equally on both surfaces defining frame 202 and seals the interface just as the current gasket 70 does. Shield assembly 200 prevents oil spray from bearing 36 from reaching the rubber seal lip 106. It should be noted that although a spray shield has described with reference to oil spray in an oil-cooled alternator, any type of cooling liquid is contemplated for use with a dynamoelectric machine employing shield assembly 200.

Referring to FIGS. 5-7, both gaskets 204 and frame 202 include aperture 210. However, aperture 210 of both gaskets 204 extend to and substantially align with peripheral edges 216 defining outside edges 218 of each drain hole 212 configured in frame 202. In this manner, aperture 210 of frame 202 is circumferentially smaller than aperture 210 in gaskets 204. In addition, both gaskets 204 and frame 202 include a plurality of spaced cutouts 220 for bolt 62 clearance along an outside circumference defining each gasket 204 and frame 202. Corresponding cutouts 220 from each gasket and frame align with each other in a sandwiched shield assembly 200 and also align with complimentary configured protrusions (not shown) extending from drive-end frame 60.

In the exemplary embodiments depicted and described with reference to FIGS. 2-8, the placement of a metal shield behind the rubber shaft seal prevents high velocity oil spray from directly contacting the seal. Currently the rubber seal lip must hold back the spraying oil while maintaining contact with the rotating shaft. The exemplary embodiments depicted and described with reference to FIGS. 2-8 allow both radial misalignment of the placement of the seal and some eccentricity of the seal contact surface of the shaft. If the shield is carried in the seal case as depicted in FIGS. 2 and 3, it is also accurately centered in the assembly.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A spray shield for a bearing assembly of an electrical machine comprising:
a shield disposed intermediate an outermost bearing and rubber seal lip of a seal, said shield having an aperture allowing a rotor shaft extending therethrough, said seal configured to at least one of reduce hydraulic pressure at said seal lip and reduce a liquid leaking through said seal lip.

2. The spray shield of claim 1, wherein said shield is metallic.

3. The spray shield of claim 1, wherein said shield is configured to reduce hydraulic pressure at said seal lip and reduce said liquid leaking through the seal lip by directing said liquid radially outward instead of toward said seal lip.

4. The spray shield of claim 1, wherein said shield includes at least one drain hole disposed radially outward away from said seal lip, said at least one drain hole being in fluid communication with an oil passage.

5. The spray shield of claim 4, wherein said at least one drain hole includes a plurality of drain holes located in positions allowing said shield to be assembled in any one of a plurality positions.

6. The spray shield of claim 5, wherein said plurality of drain holes includes six drain holes located to eliminate assembly errors and insure fluid communication between said oil passage and at least one of said six drain holes.

7. The spray shield of claim 1, wherein said outermost bearing is a drive end bearing disposed in a drive end frame of an alternator.

8. The spray shield of claim 1, wherein said shield is integrated with one of a gasket and said seal.

9. The spray shield of claim 8, wherein when said shield is integrated with said gasket, gasket material is applied to both peripheral sides defining said shield.

10. The spray shield of claim 9, wherein said shield integrated with said gasket includes a plurality of circumferentially spaced cutouts about a perimeter thereof allowing mounting thereof in a corresponding plurality of positions relative to a housing defining the electrical machine.

11. The spray shield of claim 8, wherein said gasket is disposed intermediate said bearing and said seal.

12. The spray shield of claim 8, wherein when said shield is integrated with said seal, said seal includes a seal case housing said seal lip and said shield.

13. The spray shield of claim 12, wherein shield includes a first member disposed against an outboard wall defining said seal case housing and a second member extending from a terminal end of said first member, said second member angled outward from a plane defining opposing sides defining said seal case housing.

14. The spray shield of claim 13, wherein said shield is formed of a material similar to said case and includes an aperture centrally disposed for fitting over said shaft.

15. The spray shield of claim 13, wherein said shield prevents oil spraying out of said bearing from reaching said seal lip while remaining out of contact with said shaft.

16. The spray shield of claim 1, wherein said liquid is oil and said seal is an oil seal.

17. A liquid-cooled rotating electrical machine comprising: a rotor having a longitudinal axis; a stator surrounding said rotor; one or more frames rotatably supporting said rotor, at least one of said frames having a hub with a core with an opening for receiving a bearing mounting said rotor with said hub; and a spray shield disposed intermediate said bearing and a rubber seal lip of a seal, said shield having an aperture allowing a rotor shaft extending therethrough, said seal configured to at least one of reduce hydraulic pressure at said seal lip and reduce a liquid leaking through said seal lip.

18. A method to suppress oil spray generated in a brush or brushless type rotor of a wound-field electrical machine, the method comprising:
disposing a metallic shield intermediate an outermost bearing and rubber seal lip of an oil seal, said shield having an aperture allowing a rotor shaft extending therethrough, said seal configured to at least one of reduce hydraulic pressure at said seal lip and reduce a liquid leaking through said seal lip.

19. The method of claim 18, wherein said spray shield is configured to reduce hydraulic pressure at said seal lip and reduce said liquid leaking through the seal lip by directing said liquid radially outward instead of toward said seal lip.
